(19) United States
(12) Patent Application Publication
(10) Pub. No.: US 2022/0299334 A1
(43) Pub. Date: Sep. 22, 2022

(54) RECOMMENDATION INFORMATION PROVIDING METHOD AND RECOMMENDATION INFORMATION PROVIDING SYSTEM

(71) Applicant: Panasonic Intellectual Property Management Co., Ltd., Osaka (JP)

(72) Inventors: Susumu TSUBOSAKA, Kanagawa (JP); Akira MASUO, Kanagawa (JP)

(73) Assignee: Panasonic Intellectual Property Management Co., Ltd., Osaka (JP)

(21) Appl. No.: 17/668,834

(22) Filed: Feb. 10, 2022

(30) Foreign Application Priority Data
Mar. 19, 2021 (JP) 2021-046303

(51) Int. Cl. G01C 21/36; G06F 16/9035; G06F 16/909; G06F 16/908; G06F 16/9032; G01C 21/34

(52) U.S. Cl. CPC G01C 21/3617; G06F 16/9035; G06F 16/909; G06F 16/908; G06F 16/90332; G01C 21/3407; G01C 21/3492

(57) ABSTRACT

Provided are a recommendation information providing method and a recommendation information providing system. The recommendation information providing method provides a user of a vehicle with an activity experienceable after transportation by the vehicle, by using an information providing apparatus connected to an in-vehicle machine and house equipment via a network, and includes: acquiring first information transmitted from the in-vehicle machine mounted in the vehicle and second information transmitted from the house equipment provided in a house where the user resides; selecting, based on the first information and the second information, information on the activity experienceable after transportation by the vehicle, from among activities in an activity information database in which a plurality of pieces of information on the activity is registered; and providing equipment possessed by the user with the selected information on the activity as recommendation information.

### TECHNICAL FIELD

The present disclosure relates to a recommendation information providing method and a recommendation information providing system.

### BACKGROUND ART

Patent Literature (hereinafter referred to as “PTL”) 1 discloses an apparatus that utilizes activity-related data such as hobbies and special skills of a person who utilizes a welfare facility or the like, thereby providing the person with an opportunity for a conversation.

This apparatus includes: a means of storing data on hobbies, special skills, and the like as sense-of-purpose data in a database (DB) and retrieving data on a piece of work created based on the sense-of-purpose data; a means of receiving an order of a retrieved piece of work and storing data on the order; and a dialog means of causing a person who has ordered a piece of work to have a dialog with a creator of the piece of work through a display screen.

Thus, a person who has ordered a piece of work can pose a question to a creator of the piece of work and submit a request for the piece of work to the creator. As a result, the creator of the piece of work has more opportunities for a dialog while staying in a welfare facility or the like and can lead a purposeful life.

### CITATION LIST

### Patent Literature

PTL 1
Japanese Patent Application Laid-Open No. 2014-222377

### SUMMARY OF INVENTION

### Technical Problem

In the prior art disclosed in PTL 1, however, scenes at which a person feels a sense of purpose in life are confined to when the person has a dialog through the display screen. For this reason, there is a problem that the prior art disclosed in PTL 1 is incapable of responding to a request for increasing experiences through which a person feels a sense of purpose so as to further extend his/her healthy life expectancy and lead a purposeful life.

One non-limiting and exemplary embodiment facilitates providing a recommendation information providing method and a recommendation information providing system that are capable of increasing experiences through which a person feels a sense of purpose.

### Solution to Problem

A recommendation information providing method according to an embodiment of the present disclosure provides a user of a vehicle with an activity experienceable after transportation by the vehicle, by using an information providing apparatus connected to an in-vehicle machine and house equipment via a network. The recommendation information providing method includes: acquiring first information, which is transmitted from the in-vehicle machine mounted in the vehicle, and second information, which is transmitted from the house equipment provided in a house where the user resides; selecting, based on the first information and the second information, information on the activity experienceable after transportation by the vehicle, from among activities in an activity information database in which a plurality of pieces of information on the activity is registered; and providing equipment, which is possessed by the user, with the selected information on the activity as recommendation information.

A recommendation information providing system according to an embodiment of the present disclosure provides a user of a vehicle with an activity experienceable after transportation by the vehicle. The recommendation information providing system includes: one or more processing apparatuses; and a recording apparatus that records information to cause an operation in the one or more processing apparatuses to be executed. In the recommendation information providing system, first information, which is transmitted from an in-vehicle machine mounted in the vehicle, and second information, which is transmitted from house equipment provided in a house where the user resides, are acquired, information on the activity experienceable after transportation by the vehicle is selected, based on the first information and the second information, from among activities in an activity information database in which a plurality of pieces of information on the activity is registered, and equipment possessed by the user is provided with the selected information on the activity as recommendation information.

### Advantageous Effects of Invention

According to an embodiment of the present disclosure, it is possible to provide a recommendation information providing method and a recommendation information providing system that are capable of increasing experiences thorough which a person feels a sense of purpose.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates a configuration example of recommendation information providing system 1 according to an embodiment of the present disclosure;

FIG. 2 illustrates a hardware configuration example of ECU 32;

FIG. 3A illustrates an exemplary functional configuration of recommendation information providing apparatus 52;

FIG. 3B illustrates an exemplary configuration of memory apparatus 19;

FIG. 4 illustrates a configuration example of activity information DB 23; and

FIG. 5 illustrates a flowchart provided for describing an operation of recommendation information providing apparatus 52.

### DESCRIPTION OF EMBODIMENTS

Hereinafter, preferred embodiments of the present disclosure will be described in detail with reference to the accompanying drawings. Note that, in the present specification and drawings, components having substantially the same functions are provided with the same reference signs to omit duplicated descriptions thereof.

### EMBODIMENTS

First, the background leading to the creation of embodiments according to the present disclosure will be described.

For example, the known art described in PTL 1 or the like discloses the apparatus that utilizes data on hobbies and the like of a person who utilizes a welfare facility or the like, thereby providing the person with an opportunity for a conversation.

In the known art as such, scenes at which a person feels a sense of purpose in life are confined to when the person has a dialog through the display screen. For this reason, the known art is incapable of responding to a request for increasing experiences through which a person feels a sense of purpose so as to further extend his/her healthy life expectancy and lead a purposeful life.

Given the above, it is desirable to increase experiences through which a person feels a sense of purpose. Hereinafter, embodiments according to the present disclosure will be described.

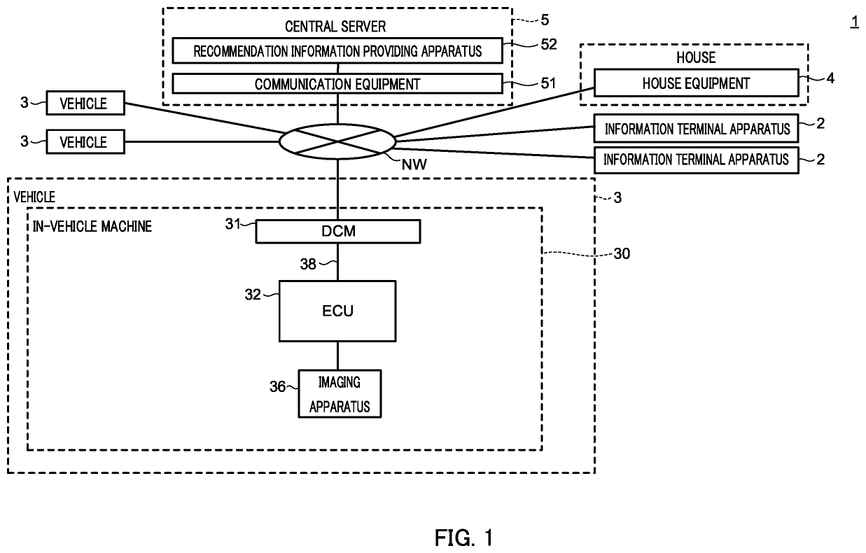

FIG. 1 illustrates a configuration example of recommendation information providing system 1 according to an embodiment of the present disclosure.

(Recommendation Information Providing System 1)

Recommendation information providing system 1 includes: a plurality of information terminal apparatuses 2; in-vehicle machines 30 mounted in a plurality of vehicles 3, respectively; house equipment 4 provided in a house; and central server 5 capable of communicating with in-vehicle machines 30.

(Information Terminal Apparatus 2)

Information terminal apparatus 2 is, for example, a personal computer, a portable smartphone, a smartwatch, or the like possessed by a driver of vehicle 3. The personal computer is a portable notebook personal computer, a stationary desktop personal computer, or the like. Information terminal apparatus 2 is an example of equipment possessed by a user of vehicle 3.

(In-Vehicle Machine 30)

In-vehicle machine 30 includes data communication module (DCM) 31, electronic control unit (ECU) 32, and imaging apparatus 36. Note that, in-vehicle machine 30 includes, in addition to those described above, a car navigation apparatus, an audio apparatus, an inverter, a motor, auxiliary machinery, and the like, for example.

(DCM 31)

DCM 31 is communication equipment that performs bidirectional communication with central server 5 via communication network NW. Communication network NW is, for example, a mobile phone network with numerous base stations as terminations, a satellite communication network utilizing a communication satellite, or the like.

Further, DCM 31 and ECU 32 are connected communicably to each other via controller area network (CAN) 38, which is an in-vehicle network, and DCM 31 transmits various information to central server 5 in response to a request from ECU 32. Note that, in addition to CAN 38, DCM 31 may also be connected to ECU 32 via a network of another standard, such as Ethernet (registered trademark).

(ECU 32)

ECU 32 is an electronic control unit that collects vehicular information and performs various control processing related to predetermined functions of vehicle 3, and examples thereof include a motor ECU, a hybrid ECU, and an engine ECU.

The vehicular information includes information on a vehicle position, a vehicle speed, a vehicle state, imaging data, and the like.

The information on a vehicle position is, for example, information on latitude and longitude, which is transmitted from a car navigation apparatus, a GPS module, or the like and indicates a position where vehicle 3 is present.

The information on a vehicle speed is transmitted from a vehicle speed sensor and indicates a current speed of vehicle 3.

The information on a vehicle state indicates, for example, an operation state of the windshield wiper, a state of the defogger, an opening of the gas pedal, a stepping amount of the brake pedal, a steered amount of the steering wheel, and the like.

The imaging data is image data imaged by imaging apparatus 36. The imaging data includes time information indicating a time when an image is generated.

(Imaging Apparatus 36)

Imaging apparatus 36 is a camera including an imaging element such as a charge coupled device (CCD) and a complementary metal oxide semiconductor (CMOS). Imaging apparatus 36 includes, for example, an internal imaging apparatus that images the interior of a vehicle.

The internal imaging apparatus is disposed in the dashboard, in the instrument panel at the driver's seat in vehicle 3, or on the ceiling of vehicle 3 so as to be capable of imaging a position of the driver present at the driver's seat, the passenger seat next to the driver's seat, or the like in vehicle 3. The internal imaging apparatus outputs imaged image data. Note that, the internal imaging apparatus is not limited to one internal imaging apparatus, but a plurality of the internal imaging apparatuses may be provided inside a vehicle.

(House Equipment 4)

House equipment 4 is, for example, a content playback apparatus, home energy management system (HEMS) equipment, a vital data measurer, or the like.

The content playback apparatus is a stationary television, a smartphone, a tablet terminal apparatus, a head-mounted display, or the like. The content is a television program broadcast from a broadcasting station, video content, or the like.

The HEMS equipment is an apparatus configured to control household electric equipment such as an air conditioner and a refrigerator in a house and to monitor power consumption of household electric equipment for each time slot.

Further, the HEMS equipment is capable of managing an electricity usage charge, a power selling charge, a charge/discharge amount of an electric vehicle, an amount of power consumption of an air conditioner, and the like. Data managed by HEMS equipment is transmitted to central server 5 via communication network NW.

The vital data measurer is a thermometer, a sphygmomanometer, a pulsimeter, a stadiometer, a body fat scale, an osteodensitometer, a blood oxygen measurer, a scale, or the like. The vital data measurer is communicably connected to communication network NW via a router (not illustrated).

Vital data measured by the vital data measurer is transmitted to central server 5 via communication network NW.

(Central Server 5)

Central server 5 is a server that provides various services by collecting information from the plurality of vehicles 3 and distributing information. Central server 5 includes communication equipment 51 and recommendation information providing apparatus 52.

Communication equipment 51 is a communication device that performs bidirectional communication with each of the plurality of vehicles 3 via communication network NW under the control of recommendation information providing apparatus 52.

Recommendation information providing apparatus 52 executes various control processing in central server 5. Recommendation information providing apparatus 52 comprises for example, a server computer including a central processing unit (CPU), a random access memory (RAM), a read only memory (ROM), an auxiliary storage apparatus, an input/output interface, and the like.

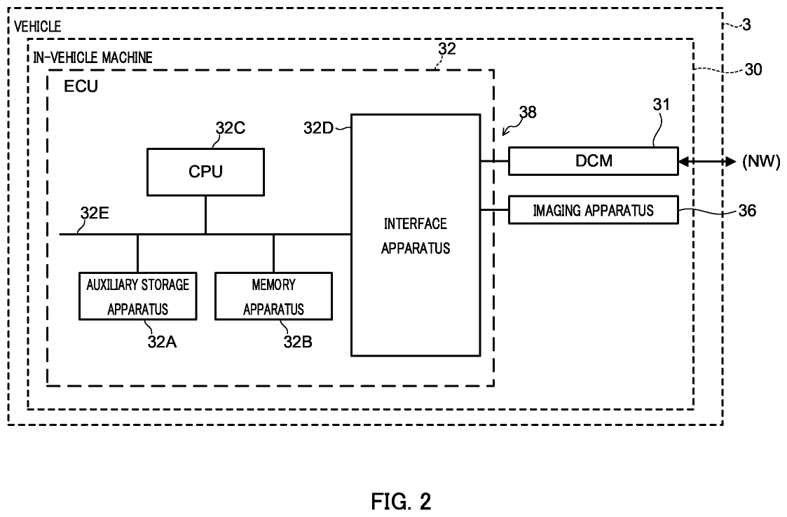

Next, a hardware configuration of ECU 32 will be described with reference to FIG. 2. FIG. 2 illustrates a hardware configuration example of ECU 32. FIG. 2 also illustrates the configurations connected to ECU 32, which are indicated in FIG. 1.

ECU 32 includes auxiliary storage apparatus 32A, memory apparatus 32B, CPU 32C, and interface apparatus 32D.

Auxiliary storage apparatus 32A, memory apparatus 32B, CPU 32C, and interface apparatus 32D are connected to each other by bus line 32E.

(Auxiliary Storage Apparatus 32A)

Auxiliary storage apparatus 32A stores files, data, or the like required for processing in ECU 32. Auxiliary storage apparatus 32A is formed of a hard disk drive (HDD), a flash memory, or the like.

(Memory Apparatus 32B)

Memory apparatus 32B reads a program from auxiliary storage apparatus 32A and stores the read program or temporarily stores data to be utilized by the program in a case where an instruction to start the program is issued.

(CPU 32C)

CPU 32C executes a program stored in memory apparatus 32B and realizes various functions of ECU 32 in accordance with the program.

(Interface Apparatus 32D)

Interface Apparatus 32D is an interface that connects CPU 32C to DCM 31, imaging apparatus 36, and the like via CAN 38.

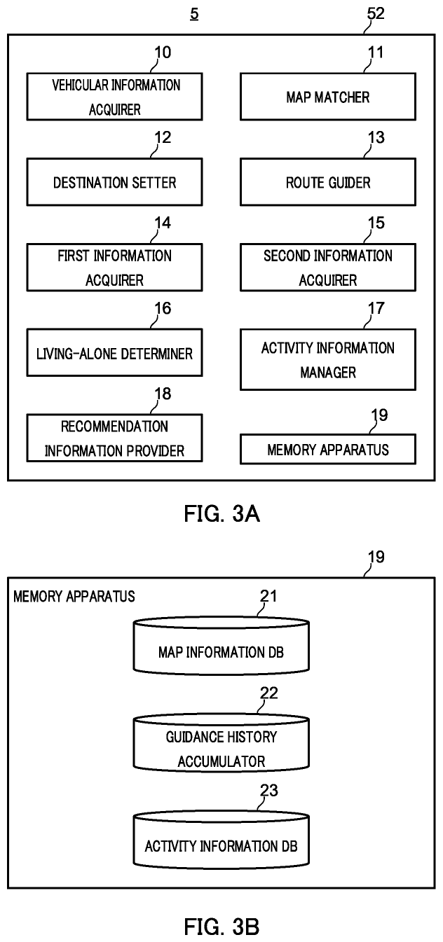

Next, a functional configuration of recommendation information providing apparatus 52 will be described with reference to FIGS. 3A and 3B. FIG. 3A illustrates an exemplary functional configuration of recommendation information providing apparatus 52. FIG. 3B illustrates an exemplary configuration of memory apparatus 19.

As illustrated in FIG. 3A, recommendation information providing apparatus 52 includes vehicular information acquirer 10, map matcher 11, destination setter 12, route guider 13, first information acquirer 14, second information acquirer 15, living-alone determiner 16, activity information manager 17, recommendation information provider 18, and memory apparatus 19.

The functions of these sections are realized by using data stored in memory apparatus 19.

(Memory Apparatus 19)

As illustrated in FIG. 3B, memory apparatus 19 includes, for example, map information data base (DB) 21 and guidance history accumulator 22, and activity information DB 23 described above.

(Map Information DB 21)

Map information DB 21 is a database in which map information is retrievably accumulated and is formed of geographic information system (GIS) data or the like. The GIS data is data including nodes corresponding to intersections, road links that connect the nodes, lines corresponding to features such as buildings or roads, polygons corresponding to features such as buildings or roads, and the like.

The map information includes, in addition to names, addresses, position information, and attribute information of points, information associated with charging facilities (charging facility information), an average staying time of users at each point, and the like.

(Guidance History Accumulator 22)

Guidance history accumulator 22 accumulates, as a guidance history, information on route guidance guided by route guider 13.

(Activity Information DB 23)

Activity information DB 23 is a database to be managed. In activity information DB 23, information on activities experienceable after transportation by vehicle 3 is registered.

(Vehicular Information Acquirer 10)

Vehicular information acquirer 10 acquires vehicular information transmitted from vehicle 3, such as a vehicle position, a vehicle speed, imaging data, an operation signal, voice data, and a vehicle moving direction.

(Map Matcher 11)

Map matcher 11 specifies a road link in which vehicle 3 is currently located, based on information stored in map information DB 21 and information on a vehicle position acquired by vehicular information acquirer 10.

For example, since a link identification (ID) is defined in advance for each of a plurality of road links forming a road network included in map information DB 21, map matcher 11 specifies a link ID of a road link in which vehicle 3 is currently located by referring to map information DB 21.

(Destination Setter 12)

For example, in a case where a user accepts an activity recommended by recommendation information provider 18, destination setter 12 sets, before vehicle 3 departs, a destination where the accepted activity is performed. Further, destination setter 12 calculates a route from a current location to a set destination. Note that, the method of setting a destination is not limited thereto, and destination setter 12 may set a destination of vehicle 3 based on a setting signal of a destination set by information terminal apparatus 2, for example.

(Route Guider 13)

Route guider 13 calculates a travel guidance route from a current location to a destination for a route selected by a user, for example, by using information on a vehicle position, information indicating a vehicle moving direction, and map information DB 21, and transmits data on the travel guide route to ECU 32 of vehicle 3.

ECU 32 that has received data on a travel guide route generates, based on the data, route information to be played back on a screen of a navigation apparatus or the like.

(First Information Acquirer 14)

First information acquirer 14 acquires first information transmitted from vehicle 3 in which a person rides.

The first information includes vehicular information, evaluation information, vital data, and the like.

(Vehicular Information)

The vehicular information to be acquired by first information acquirer 14 is information on a vehicle position, imaging data, an operation signal, voice data, a vehicle moving direction.

(Evaluation Information)

The evaluation information to be acquired by first information acquirer 14 is information indicating contents of an evaluation of an activity. The evaluation is made by a person who has utilized vehicle 3 to move to a location where the activity is performed.

For example, first information acquirer 14 specifies contents of an evaluation of an activity by performing voice recognition on voice data transmitted from vehicle 3.

For example, in a case where a person who rides in vehicle 3 after experiencing an activity utters a positive word such as “It was fun”, “I am glad that I went there”, and “I want to go there again”, first information acquirer 14 determines that the person highly evaluates the activity.

In a case where a person who rides in vehicle 3 after experiencing an activity utters a negative word such as “It was boring” and “I do not want to go there again”, first information acquirer 14 determines that the person does not highly evaluate the activity. Note that, first information acquirer 14 may specify contents of an evaluation of an activity based on a result of emotion analysis using image data acquired by the internal imaging apparatus(es).

First information acquirer 14 acquires these evaluation contents as evaluation information.

(Vital Data)

The vital data to be acquired by first information acquirer 14 is data measured by a vital data measurer provided in vehicle 3.

The vital data measurer is, for example, a sensor provided at the steering wheel, a sensor provided on the seat surface or back plate portion of a seat, or the like.

The sensor measures vital data of a person, such as an amount of perspiration, a heart rate, and a blood pressure value, and transmits the measured vital data to central server 5 via communication network NW.

(Second Information Acquirer 15)

Second information acquirer 15 acquires second information transmitted from house equipment 4, such as a content playback apparatus, HEMS equipment, and a vital data measurer, provided in a house of a person who utilizes vehicle 3.

The second information includes content playback history information, evaluation information, lifestyle habit information, voice data, vital data, and the like.

(Content Playback History Information)

The content playback history information to be acquired by second information acquirer 15 is, for example, information on a playback history of content played back by a content playback apparatus.

(Evaluation Information)

The evaluation information to be acquire by second information acquirer 15 is information indicating contents of an evaluation of content played back by a content playback apparatus. The evaluation is made by a resident of a house provided with a content playback apparatus.

For example, second information acquirer 15 specifies contents of an evaluation of an activity introduced in content by performing voice recognition on voice data transmitted from a content playback apparatus.

For example, in a case where a person who watches an activity introduced in content utters a positive word such as “It looks fun” and “I want to go there”, second information acquirer 15 determines that the person highly evaluates the activity.

In a case where a person who watches an activity introduced in content utters a negative word such as “It looks boring” and “It looks exhausting”, second information acquirer 15 determines that the person not highly evaluates the activity.

Second information acquirer 15 acquires information on these evaluation contents as evaluation information.

(Lifestyle Habit Information)

The lifestyle habit information to be acquired by second information acquirer 15 is information generated based on data managed by HEMS equipment.

For example, second information acquirer 15 analyzes data managed by HEMS equipment, and analyzes lifestyle habits of a resident of a house based on the data.

For example, second information acquirer 15 determines whether a resident of a house is a morning person or a night person, based on power consumption, an operation time, and the like of household electric equipment, which are included in data managed by HEMS equipment.

(Vital Data)

The vital data to be acquired by second information acquirer 15 is data measured by a vital data measurer provided in a house.

(Living-Alone Determiner 16)

Living-alone determiner 16 determines whether a person who rides in vehicle 3 or a resident of a house lives alone by performing image analysis known in the art based on imaging data acquired by second information acquirer 15. Living-alone determiner 16 may also determine the age and sex of a person who lives alone by performing image analysis known in the art.

Note that, recommendation information provider 18 may be provided with the function of living-alone determiner 16.

(Activity Information Manager 17)

Activity information manager 17 manages information on activities for which vehicle 3 is utilized. Hereinafter, this management of information on activities will be described.

(Configuration Example of Activity Information Manager 17)

Activity information manager 17 tallies, based on content playback history information, a number of content playbacks, a content playback time, and the like for each type of content.

Further, activity information manager 17 specifies content of which the tallied number of playbacks or playback time exceeds a predetermined threshold value. Further, activity information manager 17 acquires information on an activity corresponding to the content from attribute information associated with content data, information obtained by image analysis of content video data, and information obtained by voice recognition of content voice data.

For example, activity information manager 17 acquires, as information on an activity, a location where the activity is performed, and information on the type of the activity, and registers the information in activity information DB 23.

Further, activity information manager 17 determines whether an activity involves an opportunity for a dialog with a person, for example, by referring to a database in which the activity is stored in association with the location where the activity is performed, the type of the activity, and whether the activity involves an opportunity for a dialog with a person. Activity information manager 17 registers a determination result thereof as information on an opportunity for a dialog with a person in activity information DB 23.

Further, activity information manager 17 determines a load of an activity, for example, by referring to a database in which the activity is stored in association with the location where the activity is performed, the type of the activity, and the load of the activity. Activity information manager 17 registers a determination result thereof as information on an activity load level in activity information DB 23.

### Example 1 in a Case where Activity is Set as Repeat Target

Further, in a case where vehicle 3 travels to a location where an activity is performed, activity information manager 17 acquires information thereon from vehicular information acquirer 10. Then, in activity information DB 23, activity information manager 17 registers a flag “RELEVANT” in the column “REPEAT TARGET” of an activity to which vehicle 3 has traveled twice or more, and registers a flag “IRRELEVANT” in the column “REPEAT TARGET” of an activity to which vehicle 3 has never traveled. Note that, activity information manager 17 does not register anything in the column “REPAET TARGET” of an activity to which vehicle 3 has traveled only once.

### Example 2 in a Case where Activity is Set as Repeat Target

Note that, an elderly person may have time to spare and therefore may have more opportunities for going out. For this reason, new activities that match hobbies, preferences, and the like of an elderly person may run out in terms of recommending destinations.

However, for an elderly person who is interested in activities, such as sports, in which the elderly person can gain a sense of achievement by improving his/her skill, the elderly person can gain satisfaction in a case where the same activity that the elderly person has already experienced is recommended or even in a case where an activity similar to an activity that the elderly person has already experienced is recommended.

Accordingly, for example, activity information manager 17 provides the column “REPEAT TARGET” in an activity list managed by activity information DB 23, and assigns the flag “RELEVANT” to activities, such as sports, that allow a person to improve his/her skill. Activity information manager 17 then selects, from among a plurality of activities registered in activity information DB 23, information on an activity to which the flag indicating that a user can improve his/her skill is assigned.

For example, in a case where an activity for which “RELEVANT” is assigned to the column “REPEAT TARGET” is included in activity recommendation candidates (corresponding to the activity list described above) based on information on activities that meet hobbies, preferences, and the like of person A, activity information manager 17 preferentially recommends this activity.

Thus, by providing the column “REPEAT TARGET” in an activity list based on information on activities that meet hobbies, preferences, and the like, even an activity that an elderly person has already experienced can be recommended with a higher priority so that the elderly person can lead a purposeful life through the activity.

Note that, activity information manager 17 may be configured to provide the column “REPEAT TARGET” in an activity list with respect to, in addition to sports, activities that are performed indoors, such as language learning, music, and dance, for example, and to preferentially make a recommendation in the same manner.

Note that, although it is configured here such that activity information manager 17 automatically registers information in activity information DB 23, it may also be configured such that a manager of recommendation information providing system 1 or the like registers all or part of the information.

Thus, in a case where activity information manager 17 receives new content playback history information, activity information manager 17 specifies an activity corresponding to content of which a number of playbacks or a playback time exceeds a predetermined threshold value, and updates information registered in activity information DB 23 by using information on the specified activity.

Thus, information on activities that meet taste, hobbies, and the like of a resident of a house is registered in activity information DB 23 that has been updated.

Note that, although it is configured here such that activity information manager 17 registers information on an activity corresponding to content of which a number of playbacks or a playback time exceeds a predetermined threshold value in activity information DB 23, activity information manager 17 may perform voice recognition to thereby register an activity that is determined as being highly evaluated based on evaluation contents specified for the activity.

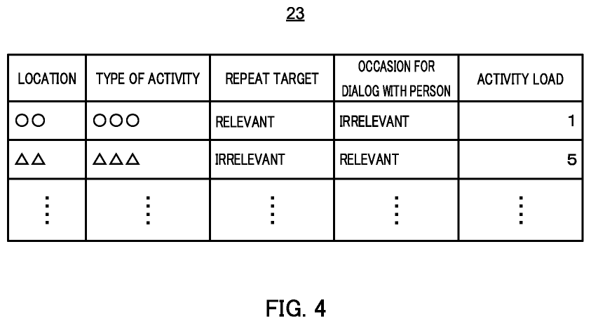

An example of information set in activity information DB 23 will be described with reference to FIG. 4. FIG. 4 illustrates a configuration example of activity information DB 23.

In activity information DB 23 illustrated in FIG. 4, the location where an activity is being performed, the type of the activity, the repeat target, the opportunity for a dialog with a person, and the activity load level are set.

As the location where an activity is being performed, the address, postcode, and the like of the location where the activity is being performed are set.

As the type of the activity, the name of the activity is set, such as shopping, scuba-diving, mountaineering, a barbecue, and the like.

As the repeat target, information indicating whether a person has repeatedly visited an activity provided by recommendation information providing apparatus 52 is set.

For example, “RELEVANT” is set therein in the case of an activity that a person has performed twice or more, whereas “IRRELEVANT” is set therein in the case of an activity that a person has never performed. In the case of an activity that a person has performed only once, nothing is set therein. Note that, in a case where activities of the same type are performed at different locations, “RELEVANT”, “IRRELEVANT” or the like may be set to each activity performed at the different locations.

As the dialog information, information indicating whether an activity provided by recommendation information providing apparatus 52 is an activity that allows an opportunity for a dialog with another person to be obtained is set.

For example, in the case of an activity in which a plurality of persons gather, such as a barbecue and an event in which car enthusiasts gather, “RELEVANT” is set therein. In the case of an activity often performed by one person, such as mountaineering and surfing, “IRRELEVANT” is set therein.

The activity load level represents a load level of a body of a person with respect to an activity. As the activity load level, a higher value is set as physical fatigue is higher. For example, in the case of mountaineering, “5” is set as the activity load level. In the case of shopping, “1” is set as the activity load level.

(Recommendation Information Provider 18)

Recommendation information provider 18 selects, from among a plurality of activities registered in activity information DB 23, an activity to be recommended based on first information acquired by first information acquirer 14, second information acquired by second information acquirer 15, and a determination result determined by living-alone determiner 16.

Recommendation information provider 18 provides a driver of vehicle 3, a passenger of vehicle 3, a resident of a house, or the like with information on a selected activity as recommendation information.

### Provision Example 1 of Recommendation Information

For example, in a case where an application that runs on information terminal apparatus 2 illustrated in FIG. 1 is operated, the application transmits a request signal requesting transmission of recommendation information on an activity to be recommended to CPU 32C.

In a case where living-alone determiner 16 of CPU 32C that has received the request signal determines a resident of a house as an elderly person who lives alone and is 60 years old or older, recommendation information provider 18 refers to activity information DB 23 and selects, from among activities of which the repeat target is “RELEVANT”, an activity, such as “shopping”, of which the activity load level is lower than a predetermined level and the opportunity for a dialog with a person is “RELEVANT”.

In a case where living-alone determiner 16 of CPU 32C that has received the request signal determines a resident of a house as a single man who is around 20 years old, recommendation information provider 18 refers to activity information DB 23 and selects, from among activities of which the repeat target is “RELEVANT”, an activity, such as “barbecue”, of which the activity load level is lower than a predetermined level and the opportunity for a dialog with a person is “RELEVANT”.

Recommendation information provider 18 transmits information on these selected activities as recommendation information to a screen of information terminal apparatus 2.

This configuration enables an elderly person living alone or a single person to obtain information on an activity that can increase opportunities for connecting with the society.

Further, since selecting an activity of which the repeat target is “RELEVANT” makes it possible to provide, as recommendation information, information on an activity that has been experienced many times, an elderly person living alone can obtain information on an activity that allows the elderly person to deepen his/her human relationships.

### Provision Example 2 of Recommendation Information

It may also be configured such that when a television installed in a house is activated, an application operating on the television transmits a request signal requesting transmission of recommendation information on an activity to be recommended to recommendation information provider 18.

For example, in a case where second information acquirer 15 acquires imaging data captured by a camera in a house when an elderly married couple of 70 years old or older is watching a television, recommendation information provider 18 analyzes an image of the imaging data.

Recommendation information provider 18 estimates the ages of the married couple watching the television, and selects an activity to be recommended based on lifestyle habit information and vital data acquired by second information acquirer 15 in view of the physical strengths and lifestyle habits of the elderly married couple.

For example, in a case where an elderly married couple of a predetermined age or older has a specific hobby such as mountaineering, recommendation information provider 18 selects information on the location of an activity associated with that hobby, of which the repeat target is “RELEVANT” and the activity load level is “5” or fewer, and transmits the information as recommendation information to the television.

Here, second information acquirer 15 may determine what hobbies the elderly married couple has, based on image analysis of the imaging data captured by the camera in the house or based on voice recognition of voice data collected by a microphone in the house.

This configuration enables even an elderly person to obtain information on an activity to be recommended.

Further, selecting an activity of which the repeat target is “RELEVANT” in a case where a person has a specific hobby such as mountaineering enables the person to improve his/her skill of the hobby and to gain a sense of achievement, and makes it possible to provide the person with a sense of satisfaction for a long time.

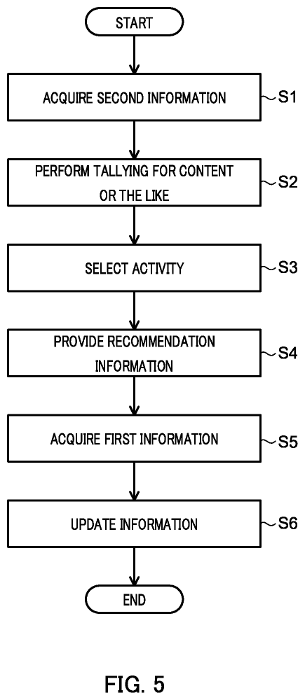

Next, an operation of recommendation information providing apparatus 52 will be described with reference to FIG. 5. FIG. 5 illustrates a flowchart provided for describing an operation of recommendation information providing apparatus 52.

In step S1, second information acquirer 15 acquires second information transmitted from house equipment 4 provided in a house where a person who utilizes vehicle 3 resides.

Next, in step S2, activity information manager 17 tallies, based on content playback history information, a number of content playbacks, a content playback time, and the like for each type of content.

Activity information manager 17 specifies an activity corresponding to content of which the tallied number of playbacks or playback time exceeds a predetermined threshold value, and registers the specified activity in association with the location where the specified activity is being performed, the type of the activity, information indicating whether the activity is an activity that allows an opportunity for a dialog with a person to be obtained, information on the load level or the like of the activity, and the like in activity information DB 23.

Next, in step S3, recommendation information provider 18 selects, based on the second information acquired by second information acquirer 15 and a determination result determined by living-alone determiner 16, an activity to be recommended by referring to activity information DB 23.

Next, in step S4, recommendation information provider 18 provides a driver of vehicle 3, a passenger of vehicle 3, a resident of a house or the like with information on the selected activity as recommendation information. Thereafter, recommendation information provider 18 executes processing in step S5.

Next, in step S5, first information acquirer 14 acquires first information transmitted from vehicle 3 in which the person rides.

Next, in step S6, recommendation information provider 18 updates information recorded in activity information DB 23 by using the first information and the provided information on the activity. For example, in a case where the person for the first time participates in an activity in which the person has not participated before, recommendation information provider 18 changes the repeat target corresponding to the activity from “IRRELEVANT” to “RELEVANT”.

Note that, although it is configured here such that information is registered in activity information DB 23 and then recommendation information is provided, the processing of registering information in activity information DB 23 and the processing of providing recommendation information may be performed in parallel.

Note that, recommendation information providing apparatus 52 according to the present embodiment may also be configured as follows.

### Other Configuration Example 1

Recommendation information provider 18 may select information on an activity to be performed at a location that a person has never visited repeatedly.

For example, in a case where there is a person who does mountaineering as a hobby, recommendation information provider 18 selects, from activity information DB 23 illustrated in FIG. 4, an activity of which the type of the activity is “mountaineering” and the repeat target is “IRRELEVANT”, and which has not been performed by the person before.

This configuration makes it possible to recommend a mountaineering course at a different location to the person who does mountaineering as a hobby, for example. Thus, even when the type of an activity to be recommended is the same, changing the location where the activity is performed enables the person to continue to participate in the activity of even the same type without getting bored.

### Other Configuration Example 2

Recommendation information provider 18 may select information on an activity to be performed at a location that a person has repeatedly visited.

For example, in a case where there is a person who does mountaineering as a hobby, recommendation information provider 18 selects, from activity information DB 23 illustrated in FIG. 4, an activity of which the type of the activity is “mountaineering” and the repeat target is “RELEVANT”, and which has been performed by the person.

This configuration makes it possible to recommend, to the person who does mountaineering as a hobby, for example, a mountaineering course located at a location where the person wishes to do mountaineering again. Thus, recommending an activity whose type is the same and which is also performed at the same location enables a person to gain various experiences for achieving his/her goal, such as doing physical exercise in preparation for being able to make a time for reaching the summit of a mountain shorter than before, or looking up a method thereof, so that an elderly person or the like can lead a purposeful life.

### Other Configuration Example 3

Recommendation information provider 18 may determine, based on second information, whether a person lives alone. In a case where the person lives alone, recommendation information provider 18 may select, from among a plurality of activities registered in activity information DB 23 illustrated in FIG. 4, an activity of which the opportunity for a dialog with a person is “RELEVANT”.

This composition enables even an elderly person living alone to increase opportunities for a dialog with a person so that the elderly person can lead a purposeful life through dialogs.

### Other Configuration Example 4

Recommendation information provider 18 may determine, based on an opening of the gas pedal of vehicle 3, a stepping amount of the brake pedal of vehicle 3, and a steered amount of the steering wheel of vehicle 3, for example, a level of driving skill of a person with respect to vehicle 3, and may select, from among a plurality of activities, information on an activity to be performed at a location accessible on a route that allows driving at a level corresponding to the determined driving skill.

For example, recommendation information provider 18 evaluates a distance to a location where an activity is performed, complexity of a route until reaching the location, and the like based on map information, compares an evaluation level obtainable from a result of the evaluation with a level of driving skill of a person, and selects, from among a plurality of activities, an activity that matches his/her driving skill.

This configuration makes it possible to recommend, depending on a level of driving skill of a person, an activity to be performed at a location to which the person can travel. For example, it is possible to recommend a walking trail course located along a road where driving is easier, or the like to an elderly person having low-level driving skill even when the elderly person does mountaineering as a hobby, instead of recommending a mountaineering course located at a location accessible by utilizing a mountain pass road or the like where high-level driving skill may be required.

### Other Configuration Example 5

Recommendation information provider 18 may also be configured as follows: recommendation information provider 18 determines, based second information, whether a person is an elderly person; in a case where recommendation information provider 18 determines that the person is an elderly person, recommendation information provider 18 determines whether there is a relative other than the elderly person; and in a case where there is a relative other than the elderly person, recommendation information provider 18 provides the relative with recommendation information.

Even in a case where an elderly person cannot drive vehicle 3 due to a decrease in the level of his/her driving skill, this configuration enables a relative of the elderly person to take the elderly person to an activity that matches hobbies and/or taste of the elderly person by providing information terminal apparatus 2 or the like possessed by the relative with information on the activity.

### Other Configuration Example 6

Recommendation information provider 18 may determine a physical strength level of a person based on vital data and select, from among a plurality of activities registered in activity information DB 23 illustrated in FIG. 4, an activity with a load level corresponding to the determined physical strength level by referring to information on the activity load level in activity information DB 23.

This configuration makes it possible to provide an activity with a load level corresponding to a physical strength level of a person so that even an elderly person with a high physical strength level can actively participate in an activity with a high load level, such as mountaineering and scuba-diving.

Further, even a person who lives alone and has a low physical strength level can participate in an activity with a low load level, such as a barbecue and shopping.

### Other Configuration Example 7

Recommendation information provider 18 may estimate a leg strength of a person based on vital data and select, from among a plurality of activities registered in activity information DB 23 illustrated in FIG. 4, an activity with a load level corresponding to the estimated leg strength by referring to information on the activity load level in activity information DB 23.

In this case, it is assumed that load levels of leg strengths required for performing each activity are registered as the activity load level in activity information DB 23.

Further, the vital data includes, for example, data such as a muscle amount, a body fat percentage, and the like measured by a scale in a house or the like, for example. Recommendation information provider 18 can recommend, based on these data, information on an activity with a load level corresponding to a leg strength of a person. Thus, even an elderly person with a decreased leg strength can actively participate in an activity with a low risk of falling or the like.

Further, a person can improve his/her physical strength level by participating in an activity with a low risk of falling or the like. Accordingly, when a person has a stronger leg strength by continuing to participate in activities, it is also possible to recommend an activity with a high load, such as mountaineering, to the person. At the same time, it is also possible to prevent a leg strength of a person from further decreasing so that a risk of his/her becoming bedridden can be reduced.

### Other Configuration Example 8

It may also be configured as follows: recommendation information provider 18 determines, based on second information, whether a person is a care receiver; in a case where recommendation information provider 18 determines that the person is a care receiver, recommendation information provider 18 determines whether there is a caregiver who takes care of the care receiver; and in a case where there is a caregiver, recommendation information provider 18 estimates a time slot that allows the caregiver to go out, and selects, from among activities managed by activity information manager 17, an activity performable in the estimated time slot.

It is possible to determine whether a person is a care receiver and whether there is a caregiver by analyzing image data included in first information or second information, for example.

Further, it is possible to estimate a time slot that allows a caregiver to go out by analyzing data acquired from HEMS equipment and determining whether a care receiver is sleeping, for example.

In a case where the time slot that allows a caregiver to go out is one hour from 9 A.M. to 10 A.M., recommendation information provider 18 selects, based on locations of activities registered in activity information DB 23 or the like, an activity to be performed at a location where the caregiver can arrive in approximately several minutes with vehicle 3 from a house, and displays the activity to a smartphone of the caregiver or the like.

In a case where the time slot that allows a caregiver can go out is six hours from noon to 6 P.M., recommendation information provider 18 selects, based on locations of activities registered in activity information DB 23 or the like, an activity to be performed at a location where the caregiver can arrive in approximately several tens of minutes with vehicle 3 from a home, and displays the activity to a smartphone of the caregiver or the like.

In recent years, the term “the elderly taking care of the elderly” has become common, and the load of elderly caregivers has become a big problem in the contemporary aging society. However, the above configuration example makes it possible to recommend an activity in which a caregiver can go out to participate so that the caregiver can refresh himself/herself from fatigue resulting from caregiving.

Further, since a caregiver can provide care in a refreshed state, a care receiver can also receive sufficient care.

Note that, it may also be configured such that information on time slots in which a caregiver can participate in each activity is registered in activity information DB 23 and recommendation information provider 18 selects an activity by taking the information into consideration as well.

### Other Configuration Example 9

Recommendation information provider 18 may increase or decrease a preparation period required for participating in an activity based on situation data on a situation of a person, such as his/her lifestyle habits and age, and may provide the person with information on the activity as recommendation information prior to a day on which the activity is performed such that the preparation period is securable.

For example, in the case of an activity involving staying overnight, it is better to secure a longer preparation period for an elderly person who has a job to participate in the activity.

Accordingly, for example, in a case where it is determined that a resident of a house is an elderly person having a job as a result of analysis of data on his/her lifestyle habits acquired from HEMS equipment and by image analysis of imaging data captured by a camera in the house, recommendation information provider 18 adds several days to a preparation period serving as a reference and provides the person with information on an activity prior to a day on which the activity is performed such that the period is securable.

In this case, for example, it is assumed that periods during which each activity can be performed are registered in activity information DB 23 in advance. Recommendation information provider 18 refers to information on the periods, selects, from among activities registered in activity information DB 23, an activity performable in view of a preparation period, and provides the person with the activity as recommendation information.

### Other Configuration Example 10

Activity information manager 17 may further register, in activity information DB 23, information on a fatigue level on a return route after an activity is performed, and may utilize the information and information on an activity load level to provide the person with information on the activity as recommendation information. The fatigue level is detected, for example, by analyzing imaging data captured by imaging apparatus 36 provided in vehicle 3.

Activity information manager 17 then registers the information on the fatigue level in association with the performed activity.

In a case where the next recommendation information is provided, recommendation information provider 18 refers to information on an allowable fatigue level designated in advance and an activity load level, selects, from among activities registered in activity information DB 23, an activity that matches a person, and provides the person with the activity as recommendation information.

Thus, it is possible to provide a person with an appropriate activity even in case where his/her physical strength decreases year by year. Note that, although both the fatigue and the activity load are utilized here, it may also be configured such that only the fatigue is utilized.

### Other Configuration Example 11

It may also be configured such that in a case where activity information manager 17 provides equipment possessed by a user with selected information on an activity as recommendation information, activity information manager 17 may notify a reason that the activity has been selected. This configuration enables the user to know the reason that the recommendation has been made, causes the user to feel convinced, and can expect an increase in his/her intention to participate in the activity.

As described above, the recommendation information providing apparatus according to the present embodiment includes: an activity information database in which information on an activity experienceable after transportation by a vehicle is registered; and a recommendation information provider which selects, based on first information, which is transmitted from an in-vehicle machine mounted in the vehicle, and second information, which is transmitted from house equipment provided in a house where a person who utilizes the vehicle resides, the activity experienceable after transportation by the vehicle, from among a plurality of activities registered in the activity information database, and provides the person with the selected information on the activity as recommendation information.

Note that, in order to increase recommendation accuracy of information on an activity, it is considered that information on evaluation determination of an activity by utilizing a sensor in the vehicle interior of vehicle 3 on a return route becomes an important element. Further, for example, the staying time of an elderly person in his/her home is long so that it is considered that his/her hobbies, preferences, and lifestyle habits can be more deeply known by acquiring information on the inside of the house.

The above configuration makes it possible to provide, for example, an elderly person who lives alone, a young person who exhibits social avoidance (social withdrawal), or the like with information on an activity experienceable when vehicle 3 is utilized, from among a plurality of activities, and to increase opportunities for participating in activities experienceable when vehicle 3 is utilized.

Further, utilization of vehicle 3 for going to a location where a recommended activity is held makes it possible to increase opportunities for contact with people.

Further, utilization of data collected by vehicle 3 in which a person who has participated in an activity rides also makes it possible to utilize an evaluation of the activity as a determination condition for the activity that is recommended next time so that information managed by activity information manager 17 can be updated to the latest state in comparison with a case where public transportation such as a bus and a train is utilized.

Note that, in a case where information terminal apparatus 2, a television in a house, or the like is caused to display information on an activity, recommendation information provider 18 may change the size of display information in view of the age of a person to whom recommendation information is provided.

Further, in a case where information terminal apparatus 2, a television in a house, or the like is caused to play back information on an activity by using voice, recommendation information provider 18 may change the playback speed in view of the age of a person to whom recommendation information is provided.

Note that, it should be understood, for example, that the following aspects also belong to the technical scope of the present disclosure.

(1) A recommendation information providing method according to an embodiment of the present disclosure provides a user of a vehicle with an activity experienceable after transportation by the vehicle, by using an information providing apparatus connected to an in-vehicle machine and house equipment via a network. The recommendation information providing method includes: acquiring first information, which is transmitted from the in-vehicle machine mounted in the vehicle, and second information, which is transmitted from the house equipment provided in a house where the user resides; selecting, based on the first information and the second information, information on the activity experienceable after transportation by the vehicle, from among activities in an activity information database in which a plurality of pieces of information on the activity is registered; and providing equipment, which is possessed by the user, with the selected information on the activity as recommendation information.

(2) The information on the activity includes a repeat target which is information indicating whether the user has repeatedly visited the activity. In the recommendation information providing method, information on an activity to be performed at a location, which has been repeatedly visited by the user, is selected based on the repeat target.

(3) The information on the activity includes a repeat target which is information indicating whether the user has repeatedly visited the activity. In the recommendation information providing method, information on an activity to be performed at a location, which has not been repeatedly visited by the user, is selected based on the repeat target.

(4) The information on the activity includes dialog information indicating whether the activity for which the vehicle is utilized is an activity that allows an opportunity for a dialog with another person to be obtained. In the recommendation information providing method, whether the user lives alone is determined based on the second information, and in a case where the user lives alone, information on the activity that allows the opportunity for the dialog to be obtained is selected from among the plurality of activities.

(5) The information on the activity includes driving skill level information indicating a level of driving skill of the user with respect to the vehicle. In the recommendation information providing method, the level of the driving skill of the user with respect to the vehicle is determined, and information on an activity to be performed at a location accessible on a route that allows driving at a level corresponding to the determined driving skill is selected from among the plurality of activities.

(6) Whether the user is an elderly person is determined based on the second information. In a case where the user is determined to be an elderly person, whether there is a relative other than the elderly person is determined. In a case where there is a relative other than the elderly person, the relative is provided with the recommendation information.

(7) The first information or the second information includes vital data on a state of a body of the user. The information on the activity includes information indicating a load level of the body with respect to the activity. In the recommendation information providing method, a physical strength level of the user is determined based on the vital data, and information on an activity with the load level corresponding to the determined physical strength level is selected from among the plurality of activities.

(8) The first information or the second information includes vital data on a state of a body of the user. The information on the activity includes information indicating a load level of the body with respect to the activity. In the recommendation information providing method, a leg strength of the user is estimated based on the vital data, and information on an activity with the load level corresponding to the estimated leg strength is selected from among the plurality of activities.

(9) In the recommendation information providing method according to an embodiment of the present disclosure, whether there is a care receiver requiring care by the user is determined based on the second information, and in a case where it is determined that there is the care receiver, a time slot that allows the user to go out is estimated, and an activity performable in the estimated time slot is selected from among the plurality of activities.

(10) The first information or the second information includes situation data on a situation of the user. In the recommendation information providing method, a preparation period required for participating in the activity is calculated based on the situation data, and the user is provided with the recommendation information such that the preparation period is securable.

(11) The information on the activity includes information on a fatigue level on a return route after the activity is performed. In the recommendation information providing method, the information on the activity experienceable after transportation by the vehicle is selected from among the plurality of activities based on the fatigue level.

(12) In the recommendation information providing method according to an embodiment of the present disclosure, information on an activity that allows the user to improve skill of the user is selected from among the plurality of activities registered in the activity information database.

(13) In the recommendation information providing method according to an embodiment of the present disclosure, in a case where the equipment possessed by the user is provided with the selected information on the activity as the recommendation information, a reason that the activity has been selected is notified.

(14) A recommendation information providing system according to an embodiment of the present disclosure provides a user of a vehicle with an activity experienceable after transportation by the vehicle. The recommendation information providing system includes: one or more processing apparatuses; and a recording apparatus that records information to cause an operation in the one or more processing apparatuses to be executed. In the recommendation information providing system, first information, which is transmitted from an in-vehicle machine mounted in the vehicle, and second information, which is transmitted from house equipment provided in a house where the user resides, are acquired, information on the activity experienceable after transportation by the vehicle is selected, based on the first information and the second information, from among activities in an activity information database in which a plurality of pieces of information on the activity is registered, and equipment possessed by the user is provided with the selected information on the activity as recommendation information.

Various embodiments have been described above with reference to the drawings. However, it goes without saying that the present disclosure is not limited to these embodiments. It is obvious that one of ordinary skill in the art can conceive various modified examples and corrected examples within the scope described in the present disclosure. It should be naturally understood that these modified examples and corrected examples belong to the technical scope of the present disclosure. Further, each component of the above embodiments may be optionally combined without departing from the spirit of the present disclosure.

The specific examples of the present disclosure have been described in detail above, but these specific examples are mere examples and do not limit the appended claims. The technology described in the appended claims may include various changes and modifications of the specific examples exemplified in the present disclosure.

While various embodiments have been described herein above, it is to be appreciated that various changes in form and detail may be made without departing from the sprit and scope of the invention(s) presently or hereafter claimed.

This application is entitled and claims the benefit of Japanese Patent Application No. 2021-046303, filed on Mar. 19, 2021, the disclosure of which including the specification, drawings and abstract is incorporated herein by reference in its entirety.

### INDUSTRIAL APPLICABILITY

An embodiment of the present disclosure is suitable for a recommendation information providing method and a recommendation information providing system.

### REFERENCE SIGNS LIST

1 Recommendation information providing system
2 Information terminal apparatus
3 Vehicle
4 House equipment
5 Central server
10 Vehicular information acquirer
11 Map matcher
12 Destination setter
13 Route guider
14 First information acquirer
15 Second information acquirer
16 Living-alone determiner
17 Activity information manager
18 Recommendation information provider
19 Memory apparatus
21 Map information DB
22 Guidance history accumulator
23 Activity information DB
30 In-vehicle machine
31 DCM
32 ECU
32A Auxiliary storage apparatus
32B Memory apparatus
32C CPU
32D Interface apparatus
32E Bus line
36 Imaging apparatus
38 CAN
51 Communication equipment
52 Recommendation information providing apparatus

1. A recommendation information providing method that provides a user of a vehicle with an activity by using an information providing apparatus connected to an in-vehicle machine and house equipment via a network, the activity being an activity experienceable after transportation by the vehicle, the recommendation information providing method comprising:
acquiring first information and second information, the first information being transmitted from the in-vehicle machine mounted in the vehicle, the second information being transmitted from the house equipment provided in a house where the user resides;
selecting, based on the first information and the second information, information on the activity experienceable after transportation by the vehicle, from among activities in an activity information database in which a plurality of pieces of information on the activity is registered; and
providing equipment with the selected information on the activity as recommendation information, the equipment being possessed by the user.

2. The recommendation information providing method according to claim 1, wherein:
the information on the activity includes a repeat target which is information indicating whether the user has repeatedly visited the activity, and
information on an activity to be performed at a location is selected based on the repeat target, the location having been repeatedly visited by the user.

3. The recommendation information providing method according to claim 1, wherein:
the information on the activity includes a repeat target which is information indicating whether the user has repeatedly visited the activity, and
information on an activity to be performed at a location is selected based on the repeat target, the location having not been repeatedly visited by the user.

4. The recommendation information providing method according to claim 1, wherein:
the information on the activity includes dialog information indicating whether the activity for which the vehicle is utilized is an activity that allows an opportunity for a dialog with another person to be obtained, and
whether the user lives alone is determined based on the second information, and in a case where the user lives alone, information on the activity that allows the opportunity for the dialog to be obtained is selected from among the plurality of activities.

5. The recommendation information providing method according to claim 1, wherein:
the information on the activity includes driving skill level information indicating a level of driving skill of the user with respect to the vehicle, and
the level of the driving skill of the user with respect to the vehicle is determined, and information on an activity to be performed at a location accessible on a route is selected from among the plurality of activities, the route allowing driving at a level corresponding to the determined driving skill.

6. The method for providing recommendation information according to claim 1, wherein:
whether the user is an elderly person is determined based on the second information, and in a case where the user is determined to be an elderly person, whether there is a relative other than the elderly person is determined, and in a case where there is a relative other than the elderly person, the relative is provided with the recommendation information.

7. The recommendation information providing method according to claim 1, wherein:
the first information or the second information includes vital data on a state of a body of the user,
the information on the activity includes information indicating a load level of the body with respect to the activity, and
a physical strength level of the user is determined based on the vital data, and information on an activity with the load level corresponding to the determined physical strength level is selected from among the plurality of activities.

8. The recommendation information providing method according to claim 1, wherein:
the first information or the second information includes vital data on a state of a body of the user,
the information on the activity includes information indicating a load level of the body with respect to the activity, and
a leg strength of the user is estimated based on the vital data, and information on an activity with the load level corresponding to the estimated leg strength is selected from among the plurality of activities.

9. The recommendation information providing method according to claim 1, wherein whether there is a care receiver requiring care by the user is determined based on the second information, and in a case where it is determined that there is the care receiver, a time slot that allows the user to go out is estimated, and an activity performable in the estimated time slot is selected from among the plurality of activities.

10. The recommendation information providing method according to claim 1, wherein:
the first information or the second information includes situation data on a situation of the user, and
a preparation period required for participating in the activity is calculated based on the situation data, and the user is provided with the recommendation information such that the preparation period is securable.

11. The recommendation information providing method according to claim 1, wherein:
the information on the activity includes information on a fatigue level on a return route after the activity is performed, and
the information on the activity experienceable after transportation by the vehicle is selected from among the plurality of activities based on the fatigue level.

12. The recommendation information providing method according to claim 1, wherein information on an activity that allows the user to improve skill of the user is selected from among the plurality of activities registered in the activity information database.

13. The recommendation information providing method according to claim 1, wherein in a case where the equipment possessed by the user is provided with the selected information on the activity as the recommendation information, a reason that the activity has been selected is notified.

14. A recommendation information providing system that provides a user of a vehicle with an activity experienceable after transportation by the vehicle, the recommendation information providing system comprising:
one or more processing apparatuses; and
a recording apparatus that records information to cause an operation in the one or more processing apparatuses to be executed, wherein
first information and second information are acquired, the first information being transmitted from an in-vehicle machine mounted in the vehicle, the second information being transmitted from house equipment provided in a house where the user resides,
information on the activity experienceable after transportation by the vehicle is selected, based on the first information and the second information, from among activities in an activity information database in which a plurality of pieces of information on the activity is registered, and
equipment possessed by the user is provided with the selected information on the activity as recommendation information.
